(19) United States
(12) Patent Application Publication
(10) Pub. No.: US 2025/0336185 A1
(43) Pub. Date: Oct. 30, 2025

(54) IMAGE GENERATION

(71) Applicant: Beijing Youzhuju Network Technology Co., Ltd., Beijing (CN)

(72) Inventors: Yi Jiang, Beijing (CN); Peize Sun, Beijing (CN); Shoufa Chen, Beijing (CN); Shilong Zhang, Beijing (CN); Zehuan Yuan, Beijing (CN)

(21) Appl. No.: 19/192,237

(22) Filed: Apr. 28, 2025

(30) Foreign Application Priority Data
Apr. 29, 2024 (CN) 202410533823.4

(51) Int. Cl. G06V 10/771; G06T 9/00

(52) U.S. Cl. CPC G06V 10/771; G06T 9/00

(57) ABSTRACT

A method for image generation includes: processing an input text sequence by using a trained language model to obtain an output sequence output by the language model, the output sequence including a plurality of indices in a language dictionary associated with the language model, the language model being trained on the language dictionary, the language dictionary including at least an index set corresponding to text encodings in a natural language and an index set corresponding to image encodings; constructing image encodings corresponding to the plurality of indices in the output sequence into a target feature map; and determining, by using a trained image decoder, a target image matching the text sequence from the target feature map, the image decoder being trained on a visual dictionary including the index set corresponding to the image encodings.

### CROSS-REFERENCE

The present application claims priority to Chinese Patent Application No. 202410533823.4, filed on Apr. 29, 2024, and entitled “METHOD, APPARATUS, DEVICE, AND STORAGE MEDIUM FOR IMAGE GENERATION”, the entirety of which is incorporated herein by reference.

### FIELD

Example embodiments of the present disclosure generally relate to the field of computer technologies, and in particular, to image generation.

### BACKGROUND

In recent years, language models have achieved great success in understanding and generating natural language texts. With their powerful learning ability and parameter expansion ability, such models are becoming the basic method in the entire field of artificial intelligence. However, the field of image generation still mainly uses previous visual models (e.g., Generative Adversarial Networks (GAN) series and Diffusion series) instead of language models.

### SUMMARY

In a first aspect of the present disclosure, there is provided a method for image generation. The method includes: processing an input text sequence by using a trained language model to obtain an output sequence output by the language model, the output sequence including a plurality of indices in a language dictionary associated with the language model, the language model being trained on the language dictionary, the language dictionary including at least an index set corresponding to text encodings in a natural language and an index set corresponding to image encodings; constructing image encodings corresponding to the plurality of indices in the output sequence into a target feature map; and determining, by using a trained image decoder, a target image matching the text sequence from the target feature map, the image decoder being trained on a visual dictionary including the index set corresponding to the image encodings.

In a second aspect of the present disclosure, there is provided an apparatus for image generation. The apparatus includes: a text sequence processing module configured to process an input text sequence by using a trained language model to obtain an output sequence output by the language model, the output sequence including a plurality of indices in a language dictionary associated with the language model, the language dictionary including at least an index set corresponding to text encodings in a natural language and an index set corresponding to image encodings, and the language model being trained on the language dictionary; a target feature map construction module configured to construct image encodings corresponding to the plurality of indices in the output sequence into a target feature map; and a target image determination module configured to determine, by using a trained image decoder, a target image matching the text sequence from the target feature map, the image decoder being trained on a visual dictionary including the index set corresponding to the image encoding.

In a third aspect of the present disclosure, there is provided an electronic device. The device includes at least one processing unit; and at least one memory coupled to the at least one processing unit and storing instructions executable by the at least one processing unit. The instructions, when executed by the at least one processing unit, cause the device to perform the method of the first aspect.

In a fourth aspect of the present disclosure, there is provided a computer-readable storage medium having stored thereon a computer program that, when executed by a processor, implements the method of the first aspect.

In a fifth aspect of the present disclosure, there is provided a computer program product including a computer program that, when executed by a processor, implements the method of the first aspect.

It should be understood that the content described in this section is not intended to limit the key features or essential features of the embodiments of the present disclosure, nor is it intended to limit the scope of the present disclosure. Other features of the present disclosure will become readily understood from the following description.

### BRIEF DESCRIPTION OF THE DRAWINGS

The above and other features, advantages and aspects of various embodiments of the present disclosure will become more apparent when taken in conjunction with the drawings and with reference to the following detailed description. In the drawings, the same or similar reference numerals denote the same or similar elements, where:

FIG. 1 illustrates a schematic diagram of an example environment in which embodiments of the present disclosure can be implemented;

FIG. 2A and FIG. 2B illustrate schematic diagrams of architectures of an image generation model according to some embodiments of the present disclosure;

FIG. 3 illustrates a schematic diagram of training of an image encoder and an image decoder according to some embodiments of the present disclosure;

FIG. 4 illustrates a schematic diagram of training of a language model according to some embodiments of the present disclosure;

FIG. 5 illustrates a schematic diagram of an environment in which embodiments of the present disclosure can be implemented;

FIG. 6 illustrates a schematic diagram of a process for image generation according to some embodiments of the present disclosure;

FIG. 7 illustrates a block diagram of an apparatus for image generation according to some embodiments of the present disclosure; and

FIG. 8 illustrates a block diagram of an electronic device in which one or more embodiments of the present disclosure can be implemented.

### DETAILED DESCRIPTION

Embodiments of the present disclosure will be described in more detail below with reference to the drawings. While certain embodiments of the present disclosure are shown in the drawings, it should be understood that the present disclosure may be implemented in various forms and should not be construed as limited to the embodiments set forth herein. Rather, these embodiments are provided for a thorough and complete understanding of the present disclosure. It should be understood that the drawings and embodiments of the present disclosure are only for exemplary purposes and are not intended to limit the protection scope of the present disclosure.

In the description of embodiments of the present disclosure, the term “include/comprise” and similar terms should be understood as open-ended inclusions, that is, “include/comprise but not limited to”. The term “based on” should be understood as “at least partially based on”. The term “an embodiment” or “the embodiment” should be understood as “at least one embodiment”. The term “some embodiments” should be understood as “at least some embodiments”. Other explicit and implicit definitions may also be included below.

It can be understood that the data involved in the technical solutions of the present disclosure (including but not limited to the data itself, the acquisition or use of the data) should comply with the requirements of corresponding laws, regulations and related provisions.

It can be understood that before using the technical solutions disclosed in the embodiments of the present disclosure, the user should be informed of the type, scope of use, use scenarios, etc. of personal information involved in the present disclosure in an appropriate way in accordance with relevant laws and regulations, and the user's authorization should be obtained.

For example, in response to receiving an active request from a user, prompt information is sent to the user to explicitly prompt the user that the requested operation will require the acquisition and use of the user's personal information, so that the user can independently choose whether to provide the personal information to software or hardware such as an electronic device, an application, a server or a storage medium that performs operations of the technical solutions of the present disclosure according to the prompt information.

As an optional but non-limiting implementation, in response to receiving an active request from a user, the prompt information may be sent to the user in the form of a pop-up window, and the prompt information may be presented in text in the pop-up window. In addition, the pop-up window may also include a selection control for the user to choose “agree” or “disagree” to provide personal information to the electronic device.

It can be understood that the above process of notifying and obtaining user authorization is only illustrative, and does not limit the implementations of the present disclosure. Other methods that meet relevant laws and regulations may also be applied to the implementations of the present disclosure.

As used herein, the term “model” may learn an association relationship between corresponding input and output from training data, so that after the training is completed, a corresponding output may be generated for a given input. The generation of the model may be based on machine learning techniques. Deep learning is a machine learning algorithm that uses multiple processing units to process input and provide corresponding output. A neural network model is an example of a deep learning-based model. As used herein, a “model” may also be referred to as a “machine learning model”, a “learning model”, a “machine learning network” or a “learning network”, which are used interchangeably herein.

A “neural network” is a machine learning network based on deep learning. The neural network can process input and provide corresponding output, and it usually includes an input layer and an output layer and one or more hidden layers between the input layer and the output layer. The neural network used in deep learning applications usually includes many hidden layers, thereby increasing the depth of the network. The layers of the neural network are connected in sequence, so that the output of the previous layer is provided as the input of the next layer, where the input layer receives the input of the neural network, and the output of the output layer is the final output of the neural network. Each layer of the neural network includes one or more nodes (also referred to as processing nodes or neurons), and each node processes input from the previous layer.

Generally, machine learning may include three stages, i.e., a training stage, a testing stage, and an application stage (also referred to as an inference stage). In the training stage, a given model may be trained using a large amount of training data, and the parameter values are continuously iteratively updated until the model can obtain consistent inference that satisfies an expected objective from the training data. Through training, the model may be considered to be capable of learning an association (also referred to as an input-to- output mapping) from input to output from the training data. The parameter values of the trained model are determined. In the testing stage, test input is applied to the trained model to test whether the model can provide correct output, thereby determining the performance of the model. The testing stage may sometimes be combined with the training stage. In the application or inference stage, the trained model may be used to process an actual model input based on the parameter values obtained from the training, and to determine a corresponding model output.

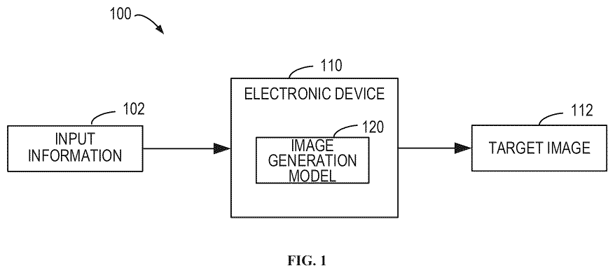

FIG. 1 illustrates a schematic diagram of an example environment 100 in which embodiments of the present disclosure can be implemented. In the environment 100, an electronic device 110 may utilize an image generation model 120 to perform an image generation task. In some implementations, the electronic device 110 may generate a target image 112 using the image generation model 120 based on input information 102.

In FIG. 1, the electronic device 110 may be any type of device with computing power, including a terminal device or a server-side device. The terminal device may be any type of mobile terminal, fixed terminal, or portable terminal, including a mobile phone, a desktop computer, a laptop computer, a notebook computer, a netbook computer, a tablet computer, a media computer, a multimedia tablet, a personal communication system (PCS) device, a personal navigation device, a personal digital assistant (PDA), an audio/video player, a digital camera/video camera, a positioning device, a TV receiver, a radio broadcast receiver, an e-book device, a gaming device, or any combination thereof, including accessories and peripherals of these devices, or any combination thereof. The server-side device may include, for example, a computing system/server, such as a mainframe, an edge computing node, a computing device in a cloud environment, and the like.

It should be understood that the structure and function of the environment 100 are described for the purpose of illustration only, without implying any limitation to the scope of the present disclosure.

The main function of the current language model is to predict the words or sentences that may appear next according to the input text information, so as to complete tasks such as intelligent questions and answers, auto-completion, machine translation, and the like. Therefore, the model architecture of the language model is mainly used to process language-related tasks. The field of image generation still mainly uses the previous visual models, and the language model cannot be used for image generation.

In order to achieve the diversity of image generation schemes, an image generation scheme based on a language model is proposed in the embodiments of the present disclosure. Specifically, an input text sequence is processed using a trained language model to obtain an output sequence output by the language model, the output sequence including a plurality of indices in a language dictionary associated with the language model, the language model being trained on the language dictionary, the language dictionary including at least an index set corresponding to text encoding in a natural language and an index set corresponding to image encoding. Image encoding corresponding to the plurality of indices in the output sequence is constructed into a target feature map. A target image matching the text sequence is determined from the target feature map using a trained image decoder, the image decoder being trained on a visual dictionary, the visual dictionary including the index set corresponding to the image encoding.

According to the solution of the present disclosure, in the task of generating an image from text, the image encoding is indexed as a “special word” in the dictionary of the language model, thus image generation depending on the language model is implemented. The input text sequence is mapped to the plurality of indices by using the language model, the image encodings corresponding to the plurality of indices are constructed into the target feature map, and the target image matching the text sequence is determined from the target feature map by using the image decoder. By combining the language model and the image decoder, cross-modal application can be implemented, which helps to break the barrier between text and image, and promote information exchange and convergence between different media forms.

Some example embodiments of the present disclosure will be described below with continued reference to the drawings.

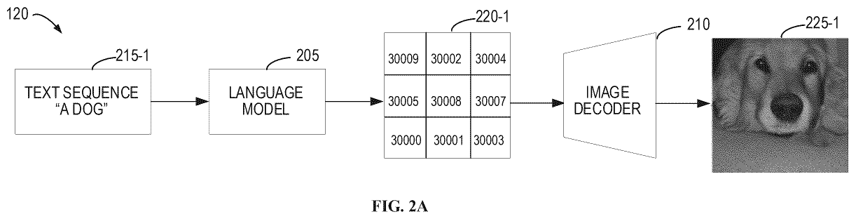

FIG. 2A and FIG. 2B illustrate schematic diagrams of architectures of the image generation model 120 according to some embodiments of the present disclosure.

As shown in FIG. 2A and FIG. 2B, in the model inference stage from text to image, the image generation model 120 used includes a trained language model 205 and a trained image decoder 210. The input text sequence 215-1 (the example in FIG. 2A) or 215-2 (the example in FIG. 2B) (collectively referred to as the text sequence 215 for convenience of description) is processed using the trained language model 205 to obtain the output sequence 220-1 or 220-2 (collectively referred to as the output sequence 220 for convenience of description) output by the language model 205. The output sequence 220 includes a plurality of indices in the language dictionary associated with the language model 205.

In the embodiments of the present disclosure, the language dictionary used to train the language model 205 includes at least an index set corresponding to text encodings in the natural language and an index set corresponding to image encodings, and the language model is trained on the language dictionary. Exemplarily, the language dictionary includes a set of indices ranging from 0 to 40000, where 0 to 29999 represents an index set corresponding to text encodings in the natural language, and 30000 to 40000 represents an index set corresponding to image encodings. For different text sequences 215, the image generation model 120 may output different output sequences 220. In the example of FIG. 2A, for the text sequence 215-1, i.e., “a dog”, the plurality of indices included in the output sequence 220-1 are {30009, 30002, 30004, . . . , 30003}. In the example of FIG. 2B, for the text sequence 215-2, i.e., “a white fox”, the plurality of indices included in the output sequence 220-2 are {30008, 30001, 30000, . . . , 30003}.

After the output sequence is obtained, the image encodings corresponding to the plurality of indices in the output sequence are constructed into the target feature map. In some embodiments, the image encodings corresponding to the plurality of indices are arranged in a predetermined order to obtain the target feature map. Taking the output sequence 220-1 in FIG. 2A as an example, each of the plurality of indices (that is {30009, 30002, 30004, . . . , 30003}) in the output sequence 220-1 corresponds to one image encoding, which may be obtained by querying the index in the language dictionary. Then, the image encodings corresponding to the plurality of indices may be arranged in the predetermined order to obtain the target feature map. The output sequence in FIG. 2B may be processed similarly. The predetermined order may be an order from upper left to lower right or from lower left to upper right in a two-dimensional image space, which is not limited in the present disclosure. The target feature map may be considered as an abstract representation of the target image, and the target feature map may be decoded into the target image. In this way, by arranging the image encodings arranged in a one-dimensional manner in the output sequence into the feature map in the two-dimensional image space in the predetermined order, the target feature map consistent with the pixel arrangement of the original image may be obtained.

After the target feature map is constructed, the target image 225-1 matching the text sequence 215-1 or the target image 225-2 matching the text sequence 215-2 is determined from the target feature map by using the trained image decoder 210. Taking the text 215-1, i.e., “a dog” as an example, the image decoder 210 may determine an image about a dog from the target feature map.

The image decoder is trained on the visual dictionary including an index set corresponding to image encodings. Here, the visual dictionary may be added to the language dictionary as part of the language dictionary. For example, an original language dictionary may include a set of indices ranging from 0 to 29999, where 0 to 29999 is the index set corresponding to text encodings in the natural language, and each text encoding may correspond to a text element, such as Chinese characters “one, two, Zhao, Qian, Sun”, etc. In one example, the index set included in the visual dictionary is 30000-40000, and the visual dictionary may be directly added to the language dictionary without modification of the indices. In another example, the index set included in the visual dictionary is 0-10000, and since the index set 0-10000 already has corresponding text encodings in the language dictionary, it is necessary to increase each index in the index set 0-10000 by 30000 (the number of indices in the language dictionary), and then add the modified visual dictionary to the language dictionary. Therefore, the range of the index set of the expanded language dictionary is 0-40000, and includes the index set corresponding to the image encodings.

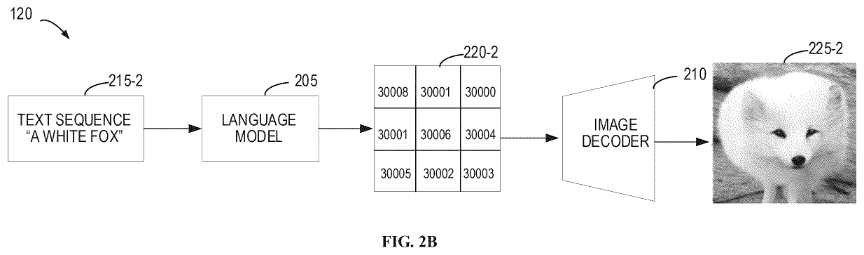

The training of the image decoder will be described below with reference to FIG. 3, which illustrates a schematic diagram 300 of the training of an image encoder and an image decoder according to some embodiments of the present disclosure. The image decoder 210 is used in conjunction with the image encoder 305.

As shown in FIG. 3, the image decoder 210 is trained by: processing an input first sample image 315 by using an image encoder 305 and the image decoder 210 that are being trained to obtain a reconstructed image 320 corresponding to the first sample image 315; and jointly training the image encoder 305 and the image decoder 210 based on a predetermined first training objective, the first training objective being configured to reduce or minimize a difference between the first sample image 315 and the reconstructed image 320. In the training process, the image encoder 305 may compress the first sample image 315 into an encoded representation, and the image decoder 210 may decode, from the encoded representation, the reconstructed image corresponding to the first sample image. In order to measure the quality of the reconstructed image 320, a loss function may be used to calculate the difference between the reconstructed image and the first sample image. The loss function may include, for example, a mean squared error loss function, a cross entropy loss function, and the like. Specifically, in the training process, gradients of the loss function with respect to parameters of the image encoder 305 and the image decoder 210 may be calculated, and then the parameters are updated according to these gradients.

Although only a single example sample image is shown in the figure, the training process of the image decoder 210 and the image encoder 305 may be based on a certain amount of sample images. The parameter update process of the image encoder and the image decoder may be iterated many times until a preset number of training rounds is reached or the value of the loss function converges to a low level. By jointly training the image encoder 305 and the image decoder 210, the compression efficiency of the image encoder 305 on the original image may be improved, and the quality of the reconstructed image of the image decoder 210 may be improved, thereby reducing the overhead of data transmission and storage while ensuring the image quality.

In some embodiments, a first sample feature map may be extracted from the first sample image 315 by using the image encoder 305, the first sample feature map including a plurality of sample image encodings. The size of the first sample image 315 may be (H, W, 3), where H represents the height of the first sample image 315, W represents the width of the first sample image 315, and 3 represents the number of RGB pixel channels. After the first sample image 315 passes through the image encoder 305, the first sample feature map is extracted. The size of the first sample feature map may be (h, w, c), where h represents the height of the first sample feature map, w represents the width of the first sample feature map, and c represents the number of channels of the first sample feature map (e.g., between 8-300), that is, an image is represented by h×w c-dimensional feature vectors.

After the first sample feature map is extracted, a plurality of first sample indices 325 associated with the plurality of sample image encodings in the first sample feature map may be determined based on the visual dictionary. The size of the visual dictionary may be (K, c), where K represents the number of feature vectors (sometimes also referred to as image encodings) in the visual dictionary (e.g., between 4000-20000), and c represents the number of channels of the feature vector and is consistent with c in the size (h, w, c) of the first sample feature map. By querying the visual dictionary, the plurality of first sample indices 325 associated with the plurality of sample image encodings in the first sample feature map may be determined, and each first sample index is between a range from 0 to K. Exemplarily, the plurality of first sample indices 325 may be understood as a group of special words 330, which are different from meaningful words in the natural language. That is, although the image encoding is understood as a special word by the language model, the purpose of image generation can be realized.

In some embodiments, the plurality of first sample indices 325 associated with the plurality of sample image encodings may be determined from the visual dictionary based on distances between the plurality of sample image encodings in the first sample feature map and respective image encodings in the visual dictionary. Taking the size of the first sample feature map being (h, w, c) as an example, for each of the h×w c-dimensional image encoding, its nearest neighbor image encoding in the visual dictionary is found. Exemplarily, the nearest neighbor image encoding in the visual dictionary may be found by comparing the Euclidean distance between each image encoding in the first sample feature map and each image encoding in the visual dictionary. The index of each nearest neighbor image encoding may be used to form the plurality of first sample indices associated with the plurality of sample image encodings. In this way, the similarity between image encodings may be quantified based on the distances between the plurality of sample image encodings in the first sample feature map and respective image encodings in the visual dictionary, so that the image encodings most similar to the sample image encodings may be efficiently found in the visual dictionary.

In some embodiments, after the plurality of first sample indices 325 are determined, the image encodings corresponding to the plurality of first sample indices 325 in the visual dictionary may be constructed into a reconstructed feature map, and the reconstructed image 320 may be decoded from the reconstructed feature map by using the image decoder 210. Exemplarily, there are h×w indices in the first sample indices 325, and for each index, the image encoding corresponding to this index in the visual dictionary is found, so as to form a feature map with a size of (h, w, c). The composition method may be to arrange each image encoding in a predetermined order, and the predetermined order is not limited to the order from upper left to lower right, the order from lower left to upper right, and the like. The image decoder 210 may decode a reconstructed image with a size of (H, W, 3) from the feature map with a size of (h, w, c).

In some embodiments, the image encodings in the visual dictionary have the same dimensionality as the number of channels of the target feature map. Exemplarily, the size of the visual dictionary is (K, c₁), where c1 represents the dimensionality of the image encoding, and the size of the target feature map is (h, w, c₂), where c2 represents the number of channels of the target feature map, and c₁ and c₂ may be the same.

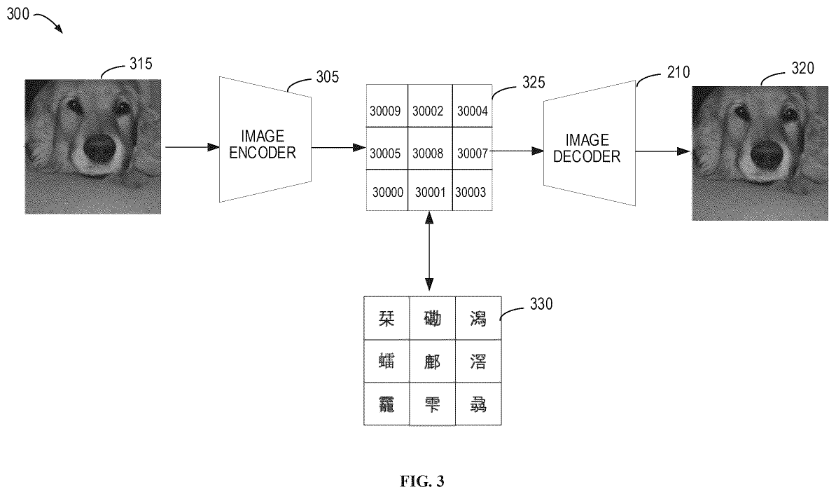

After the image encoder and the image decoder are trained, the language model may continue to be trained. The training of the language model 205 will be described below with reference to FIG. 4, which illustrates a schematic diagram 400 of the training of a language model according to some embodiments of the present disclosure.

As shown in FIG. 4, the trained image encoder 305 will be used in the training process of the language model 205. The language model 205 is trained by: extracting a second sample feature map from a second sample image 415 by using the trained image encoder 305, the second sample feature map including a plurality of sample image encodings; and determining, based on the visual dictionary, a plurality of second sample indices 420 corresponding to the plurality of sample image encodings in the second sample feature map. The trained image encoder 305 may accurately extract the second sample feature map of the second sample image 415, and the plurality of second sample indices 420 corresponding to the plurality of sample image encodings in the second sample feature map may be determined by querying the visual dictionary, and the plurality of second sample indices 420 may be considered as ground-truth. In some embodiments, the sample image used in the training process of the language model 205 may be the sample image used in the training process of the image decoder 210, or the sample images used in the two training stages may partially overlap or completely do not overlap.

In some embodiments, after obtaining the plurality of second sample indices 420 considered as ground-truth, the language model 205 is further trained by: processing, by using the language model 205 that is being trained, a sample text sequence 425 matching the second sample image to obtain a sample output sequence 430; and training the language model based on a predetermined second training objective, the second training objective being configured to reduce or minimize a difference 435 between the plurality of second sample indices 420 and the sample output sequence 430. The language model 205 that is being trained may map the sample text sequence 425 to the sample output sequence 430 corresponding to the image encodings. In order to measure whether the sample output sequence 430 is accurate, a loss function may be used to calculate the difference 435 between the plurality of second sample indices 420 and the sample output sequence 430. The loss function may include, for example, a mean squared error loss function, a cross entropy loss function, and the like. Specifically, in the training process, gradients of the loss function with respect to parameters of the language model 205 may be calculated, and then the parameters are updated according to these gradients. This process may be iterated many times until a preset number of training rounds is reached or the value of the loss function converges to a low level. In this way, the learning direction of the language model 205 may be guided, so that the language model 205 may generate a more accurate sample text sequence 425.

With continued reference to FIG. 2A and FIG. 2B, in some embodiments, the construction of the target feature map and the determination of the target image are performed in response to a detection of an image generation indication. Exemplarily, a “drawing” option and a “question answering” option (not shown in the figure) may be provided on a user interface. If the user chooses the “drawing” option and the input text sequence 215 is “a dog”, the image generation model 120 (including the trained language model 205 and the trained image decoder 210) is invoked to generate the target image corresponding to “a dog”. If the user chooses the “question answering” option and the input text sequence 215 is “a dog”, only the trained language model 205 is invoked to generate a text description related to the dog. In this way, the user's needs can be clearly known, so that a correct answer can be generated.

In some embodiments, the construction of the target feature map and the determination of the target image are performed based on an intention of the text sequence 215 input to the language model 205. The trained language model 205 may further be trained to identify the intention of the input text sequence 215. For example, in the case where the text sequence 215 is “draw a dog”, the image generation model 120 is invoked to generate the target image corresponding to “a dog”. In the case where the input text sequence 215 is “describe a dog”, only the trained language model 205 is invoked to generate a text description related to the dog, without the need to provide the output sequence to the image decoder 210.

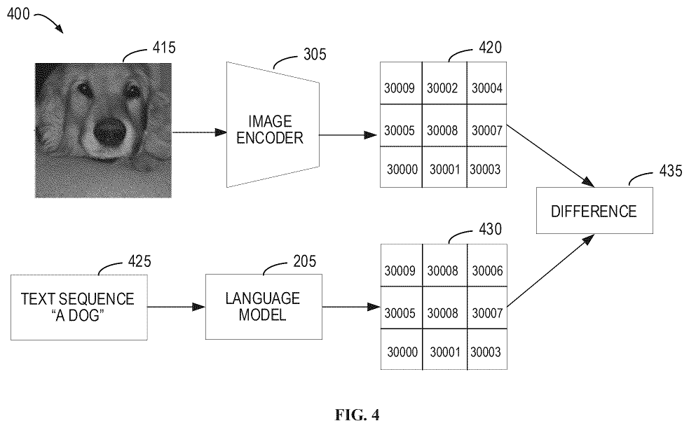

FIG. 5 illustrates a schematic diagram of an environment 500 in which embodiments of the present disclosure can be implemented. In the environment 500 of FIG. 5, it is generally shown that the model involves different stages, including a training stage 502 and an application stage 506. There may also be a testing stage after the training stage, which is not shown in the figure.

In the training stage 502, a model training system 510 is configured to perform training of a model 505 using a training dataset 512. The model 505 may be, for example, the image generation model 120 in FIG. 1 and FIG. 2A to 2B. At the start of the training, the model may have initial parameter values. The training process is to update the parameter values of the model 505 to desired values based on the training data.

In the application stage 506, the obtained model 505 with trained parameter values may be provided to a model application system 530 for use. In the application stage 506, the model 505 may be used to process a corresponding target input 532 in an actual scenario and provide a corresponding target output 534. The model application system 530 may be configured to implement the electronic device 110 of FIG. 1.

In FIG. 5, the model training system 510 and the model application system 530 may include any computing system with computing power, such as various computing devices/systems, terminal devices, servers, etc. The terminal device may involve any type of mobile terminal, fixed terminal, or portable terminal, including a mobile phone, a desktop computer, a laptop computer, a notebook computer, a netbook computer, a tablet computer, a media computer, a multimedia tablet, or any combination thereof, including accessories and peripherals of these devices, or any combination thereof. The server includes, but is not limited to, a mainframe, an edge computing node, a computing device in a cloud environment, and the like.

It should be understood that the components and arrangement in the environment 500 shown in FIG. 5 are merely examples, and a computing system suitable for implementing the exemplary implementations described in the present disclosure may include one or more different components, other components, and/or different arrangements. For example, although shown as separate, the model training system 510 and the model application system 530 may be integrated in the same system or device. The implementations of the present disclosure are not limited in this respect.

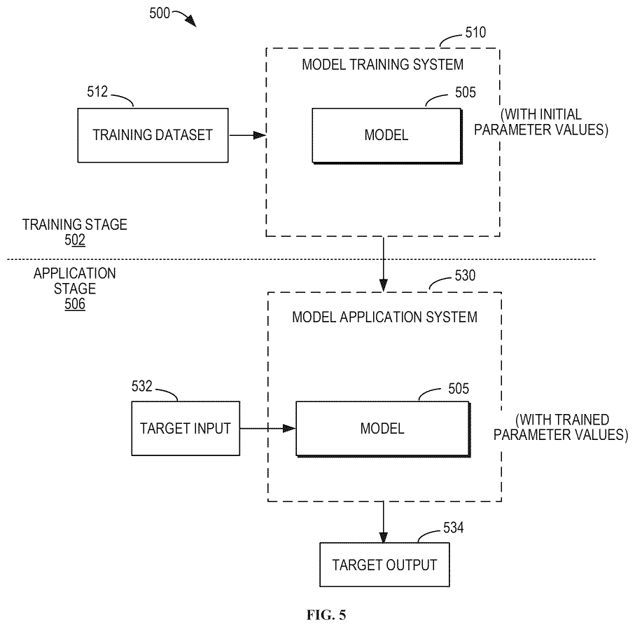

FIG. 6 illustrates a schematic diagram of a process 600 for image generation according to some embodiments of the present disclosure. The process 600 may be implemented at the electronic device 110 of FIG. 1.

At block 610, the electronic device 110 processes an input text sequence by using a trained language model to obtain an output sequence output by the language model, the output sequence including a plurality of indices in a language dictionary associated with the language model, the language model being trained on the language dictionary, the language dictionary including at least an index set corresponding to text encodings in a natural language and an index set corresponding to image encodings.

At block 620, the electronic device 110 constructs image encodings corresponding to the plurality of indices in the output sequence into a target feature map.

At block 630, the electronic device 110 determines, by using a trained image decoder, a target image matching the text sequence from the target feature map, the image decoder being trained on a visual dictionary, the visual dictionary including the index set corresponding to the image encodings. The training of the image generation model may be implemented locally by the electronic device 110 or may be implemented remotely. In the case of remote implementation, the electronic device 110 may obtain the trained image generation model from a remote device for use.

In some embodiments, the image decoder is trained by: processing an input first sample image by using an image encoder and the image decoder that are being trained to obtain a reconstructed image corresponding to the first sample image; and jointly training the image encoder and the image decoder based on a predetermined first training objective, the first training objective being configured to reduce or minimize a difference between the first sample image and the reconstructed image.

In some embodiments, processing the first sample image by using the image encoder and the image decoder to obtain the reconstructed image includes: extracting a first sample feature map from the first sample image by using the image encoder, the first sample feature map including a plurality of sample image encodings; determining, based on the visual dictionary, a plurality of first sample indices associated with the plurality of sample image encodings in the first sample feature map; constructing image encodings corresponding to the plurality of first sample indices in the visual dictionary into a reconstructed feature map; and decoding, by using the image decoder, the reconstructed image from the reconstructed feature map.

In some embodiments, determining the plurality of first sample indices includes: determining, based on distances between the plurality of sample image encodings in the first sample feature map and respective image encodings in the visual dictionary, the plurality of first sample indices associated with the plurality of sample image encodings from the visual dictionary.

In some embodiments, the language model is trained by: extracting a second sample feature map from a second sample image by using a trained image encoder, the second sample feature map including a plurality of sample image encodings; determining, based on the visual dictionary, a plurality of second sample indices corresponding to the plurality of sample image encodings in the second sample feature map; processing, by using the language model that is being trained, a sample text sequence matching the second sample image to obtain a sample output sequence; and training the language model based on a predetermined second training objective, the second training objective being configured to reduce or minimize a difference between the plurality of second sample indices and the sample output sequence.

In some embodiments, constructing the image encoding corresponding to the plurality of indices in the output sequence into the target feature map includes: arranging the image encodings corresponding to the plurality of indices in a predetermined order to obtain the target feature map.

In some embodiments, the image encodings in the visual dictionary have the same dimensionality as a number of channels of the target feature map.

In some embodiments, the construction of the target feature map and the determination of the target image are performed in response to a detection of an image generation indication.

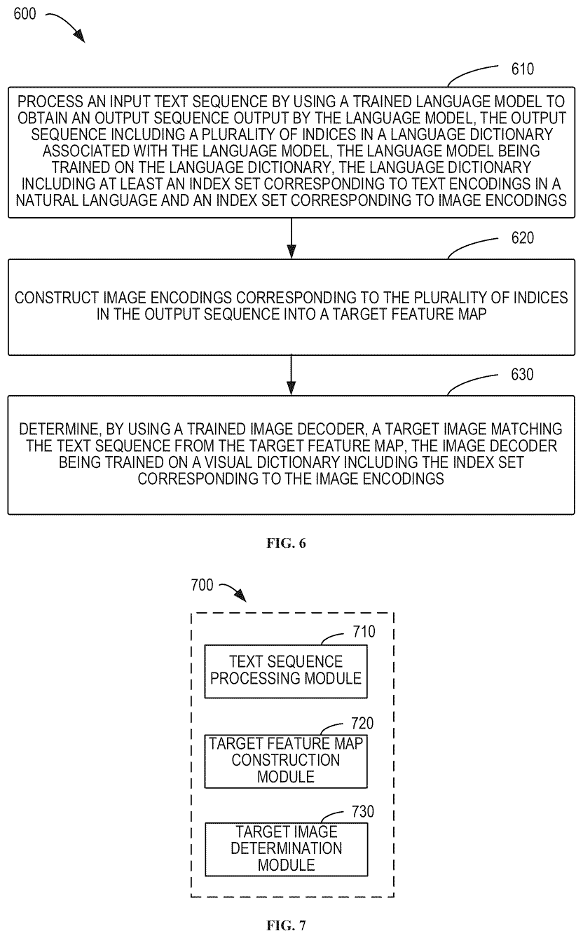

FIG. 7 illustrates a block diagram of an apparatus 700 for image generation according to some embodiments of the present disclosure. The apparatus 700 may be implemented at or included in the electronic device 110 of FIG. 1. The modules/components in the apparatus 700 may be implemented by hardware, software, firmware, or any combination thereof.

As shown, the apparatus 700 includes a text sequence processing module 710 configured to process an input text sequence by using a trained language model to obtain an output sequence output by the language model, the output sequence including a plurality of indices in a language dictionary associated with the language model, the language dictionary including at least an index set corresponding to text encodings in a natural language and an index set corresponding to image encodings, and the language model being trained on the language dictionary. The apparatus 700 includes a target feature map construction module 720 configured to construct image encodings corresponding to the plurality of indices in the output sequence into a target feature map. The apparatus 700 includes a target image determination module 730 configured to determine, by using a trained image decoder, a target image matching the text sequence from the target feature map, the image decoder being trained on a visual dictionary, the visual dictionary including the index set corresponding to the image encodings. The training of the image generation model may be implemented locally by the apparatus 700 or may be implemented remotely. In the case of remote implementation, the apparatus 700 may obtain the trained image generation model from a remote device for use.

In some embodiments, the apparatus 700 includes an image decoder training module configured to process an input first sample image by using an image encoder and the image decoder that are being trained to obtain a reconstructed image corresponding to the first sample image; and jointly train the image encoder and the image decoder based on a predetermined first training objective, the first training objective being configured to reduce or minimize a difference between the first sample image and the reconstructed image.

In some embodiments, the image decoder training module includes a reconstructed image obtaining module configured to extract a first sample feature map from the first sample image by using the image encoder, the first sample feature map including a plurality of sample image encodings; determine, based on the visual dictionary, a plurality of first sample indices associated with the plurality of sample image encodings in the first sample feature map; construct image encodings corresponding to the plurality of first sample indices in the visual dictionary into a reconstructed feature map; and decode, by using the image decoder, the reconstructed image from the reconstructed feature map.

In some embodiments, the reconstructed image obtaining module includes a first sample index determination module configured to determine, based on distances between the plurality of sample image encodings in the first sample feature map and respective image encodings in the visual dictionary, the plurality of first sample indices associated with the plurality of sample image encodings from the visual dictionary.

In some embodiments, the apparatus 700 includes a language model training module configured to extract a second sample feature map from a second sample image by using a trained image encoder, the second sample feature map including a plurality of sample image encodings; determine, based on the visual dictionary, a plurality of second sample indices corresponding to the plurality of sample image encodings in the second sample feature map; process, by using the language model that is being trained, a sample text sequence matching the second sample image to obtain a sample output sequence; and train the language model based on a predetermined second training objective, the second training objective being configured to reduce or minimize a difference between the plurality of second sample indices and the sample output sequence.

In some embodiments, the target feature map construction module 720 includes an image encoding arrangement module configured to arrange the image encodings corresponding to the plurality of indices in a predetermined order to obtain the target feature map.

In some embodiments, the image encoding in the visual dictionary have the same dimensionality as a number of channels of the target feature map.

In some embodiments, the construction of the target feature map and the determination of the target image are performed in response to a detection of an image generation indication.

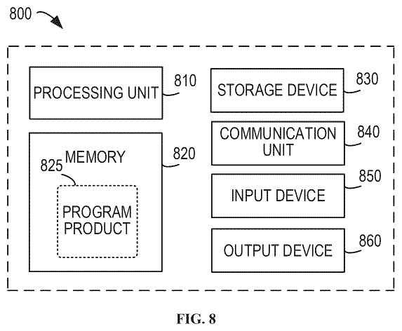

FIG. 8 illustrates a block diagram of an electronic device 800 in which one or more embodiments of the present disclosure can be implemented. It should be understood that the electronic device 800 shown in FIG. 8 is only exemplary, and should not constitute any limitation to the function and scope of the embodiments described herein. The electronic device 800 shown in FIG. 8 may be used to implement the electronic device 110 of FIG. 1 or the apparatus 700 of FIG. 7.

As shown in FIG. 8, the electronic device 800 is in the form of a general computing device. Components of the electronic device 800 may include, but are not limited to, one or more processors or processing units 810, a memory 820, a storage device 830, one or more communication units 840, one or more input devices 850, and one or more output devices 860. The processing unit 810 may be a physical or virtual processor and may perform various processes according to programs stored in the memory 820. In a multiprocessor system, multiple processing units execute computer executable instructions in parallel to improve the parallel processing capability of the electronic device 800.

The electronic device 800 typically includes multiple computer storage medium. Such medium may be any available medium that is accessible by the electronic device 800, including but not limited to, volatile and non-volatile medium, detachable and non-detachable medium. The memory 820 may be a volatile memory (for example, register, cache, Random Access Memory (RAM)), a non-volatile memory (for example, Read-Only Memory (ROM), Electrically Erasable Programmable Read-Only Memory (EEPROM), flash), or a certain combination thereof. The storage device 830 may be a detachable or non-detachable medium, and may include a machine-readable medium, such as a flash drive, a magnetic disk, or any other medium, which may be used to store information and/or data and may be accessed within the electronic device 800.

The electronic device 800 may further include additional detachable/non-detachable, volatile/non-volatile storage medium. Although not shown in FIG. 8, a disk drive for reading from or writing into a detachable, non-volatile disk (for example, a “floppy disk”) and an optical disk drive for reading from or writing into a detachable, non-volatile optical disk may be provided. In these cases, each drive may be connected to a bus (not shown) by one or more data medium interfaces. The memory 820 may include a computer program product 825 having one or more program modules, which are configured to perform various methods or acts of various embodiments of the present disclosure.

The communication unit 840 implements communication with other electronic devices through communication media. Additionally, the functions of components of the electronic device 800 may be implemented by a single computing cluster or multiple computing machines that can communicate through communication connections. Therefore, the electronic device 800 may operate in a networked environment using logical connections with one or more other servers, network personal computers (PCs), or other network nodes.

The input device 850 may be one or more input devices, such as a mouse, a keyboard, a trackball, etc. The output device 860 may be one or more output devices, such as a display, a speaker, a printer, etc. The electronic device 800 may also communicate with one or more external devices (not shown) such as storage devices, display devices, etc., communicate with one or more devices that enable the user to interact with the electronic device 800, or communicate with any device (such as a network card, a modem, etc.) that enables the electronic device 800 to communicate with one or more other electronic devices through the communication unit 840, as required. Such communication may be performed via an input/output (I/O) interface (not shown).

According to an exemplary implementation of the present disclosure, a computer-readable storage medium having computer-executable instructions stored thereon is provided, where the computer-executable instructions are executed by a processor to implement the method described above. According to an exemplary implementation of the present disclosure, a computer program product is further provided. The computer program product is tangibly stored on a non-transitory computer-readable medium and includes computer-executable instructions, and the computer-executable instructions are executed by a processor to implement the method described above.

Various aspects of the present disclosure are described herein with reference to flowcharts and/or block diagrams of methods, apparatuses, devices, and computer program products implemented in accordance with the present disclosure. It should be understood that each block of the flowcharts and/or block diagrams and combinations of blocks in the flowcharts and/or block diagrams may be implemented by computer-readable program instructions.

These computer-readable program instructions may be provided to a processing unit of a general-purpose computer, a special-purpose computer, or other programmable data processing apparatus to produce a machine, such that the instructions, when executed by the processing unit of the computer or other programmable data processing apparatus, produce a means for implementing the functions/acts specified in one or more blocks of the flowcharts and/or block diagrams. These computer-readable program instructions may also be stored in a computer-readable storage medium, and these instructions cause the computer, the programmable data processing apparatus, and/or other devices to work in a specific way, so that the computer-readable medium storing the instructions includes an article of manufacture, which includes instructions for implementing various aspects of the functions/acts specified in one or more blocks of the flowcharts and/or block diagrams.

The computer-readable program instructions may be loaded onto a computer, other programmable data processing apparatus, or other device, causing a series of operational steps to be performed on the computer, other programmable data processing apparatus, or other device to produce a computer-implemented process, such that the instructions executed on the computer, other programmable data processing apparatus, or other device implement the functions/acts specified in one or more blocks of the flowcharts and/or block diagrams. The flowcharts and block diagrams in the drawings show possible architectures, functions, and operations of the system, method, and computer program product implemented according to multiple implementations of the present disclosure. In this regard, each block in the flowcharts or block diagrams may represent a module, a program segment, or a portion of an instruction, where the module, program segment, or portion of the instruction includes one or more executable instructions for implementing the specified logical function. In some alternative implementations, the functions marked in the blocks may also occur in a different order from the order marked in the drawings. For example, two consecutive blocks may actually be executed substantially in parallel, or sometimes may be executed in the reverse order, depending on the functions involved. It should also be noted that each block in the block diagrams and/or flowcharts and combinations of blocks in the block diagrams and/or flowcharts may be implemented by a dedicated hardware-based system that performs the specified functions or acts, or may be implemented by a combination of dedicated hardware and computer instructions.

Various implementations of the present disclosure have been described above, and the above description is exemplary, not exhaustive, and is not limited to the disclosed implementations. Many modifications and changes are obvious to ordinary technical personnel in this technical field without departing from the scope and spirit of the described implementations. The selection of terms used in this article is intended to best explain the principles, practical applications, or improvements of technologies in the market of the implementations, or to enable other ordinary technical personnel in this technical field to understand the various implementations disclosed in this article.

1. A method for image generation, comprising:
processing an input text sequence by using a trained language model to obtain an output sequence output by the language model, the output sequence comprising a plurality of indices in a language dictionary associated with the language model, the language dictionary comprising at least an index set corresponding to text encodings in a natural language and an index set corresponding to image encodings, and the language model being trained on the language dictionary;
constructing image encodings corresponding to the plurality of indices in the output sequence into a target feature map; and
determining, by using a trained image decoder, a target image matching the text sequence from the target feature map, the image decoder being trained on a visual dictionary comprising the index set corresponding to the image encodings.

2. The method according to claim 1, wherein the image decoder is trained by:
processing an input first sample image by using an image encoder and the image decoder that are being trained to obtain a reconstructed image corresponding to the first sample image; and
jointly training the image encoder and the image decoder based on a predetermined first training objective, the first training objective being configured to reduce or minimize a difference between the first sample image and the reconstructed image.

3. The method according to claim 2, wherein processing the first sample image by using the image encoder and the image decoder to obtain the reconstructed image comprises:
extracting a first sample feature map from the first sample image by using the image encoder, the first sample feature map comprising a plurality of sample image encodings;
determining, based on the visual dictionary, a plurality of first sample indices associated with the plurality of sample image encodings in the first sample feature map;
constructing image encoding corresponding to the plurality of first sample indices in the visual dictionary into a reconstructed feature map; and
decoding, by using the image decoder, the reconstructed image from the reconstructed feature map.

4. The method according to claim 3, wherein determining the plurality of first sample indices comprises:
determining, based on distances between the plurality of sample image encodings in the first sample feature map and respective image encodings in the visual dictionary, the plurality of first sample indices associated with the plurality of sample image encodings from the visual dictionary.

5. The method according to claim 1, wherein the language model is trained by:
extracting a second sample feature map from a second sample image by using a trained image encoder, the second sample feature map comprising a plurality of sample image encodings;
determining, based on the visual dictionary, a plurality of second sample indices corresponding to the plurality of sample image encodings in the second sample feature map;
processing, by using the language model that is being trained, a sample text sequence matching the second sample image to obtain a sample output sequence; and
training the language model based on a predetermined second training objective, the second training objective being configured to reduce or minimize a difference between the plurality of second sample indices and the sample output sequence.

6. The method according to claim 1, wherein constructing the image encodings corresponding to the plurality of indices in the output sequence into the target feature map comprises:
arranging the image encodings corresponding to the plurality of indices in a predetermined order to obtain the target feature map.

7. The method according to claim 1, wherein the image encodings in the visual dictionary have the same dimensionality as a number of channels of the target feature map.

8. The method according to claim 1, wherein the construction of the target feature map and the determination of the target image are performed in response to a detection of an image generation indication.

9. An electronic device, comprising:
at least one processing unit; and
at least one memory coupled to the at least one processing unit and storing instructions executable by the at least one processing unit, the instructions, when executed by the at least one processing unit, causing the device to perform acts comprising:
processing an input text sequence by using a trained language model to obtain an output sequence output by the language model, the output sequence comprising a plurality of indices in a language dictionary associated with the language model, the language dictionary comprising at least an index set corresponding to text encodings in a natural language and an index set corresponding to image encodings, and the language model being trained on the language dictionary;
constructing image encodings corresponding to the plurality of indices in the output sequence into a target feature map; and
determining, by using a trained image decoder, a target image matching the text sequence from the target feature map, the image decoder being trained on a visual dictionary comprising the index set corresponding to the image encodings.

10. The device according to claim 9, wherein the image decoder is trained by:
processing an input first sample image by using an image encoder and the image decoder that are being trained to obtain a reconstructed image corresponding to the first sample image; and
jointly training the image encoder and the image decoder based on a predetermined first training objective, the first training objective being configured to reduce or minimize a difference between the first sample image and the reconstructed image.

11. The device according to claim 10, wherein processing the first sample image by using the image encoder and the image decoder to obtain the reconstructed image comprises:
extracting a first sample feature map from the first sample image by using the image encoder, the first sample feature map comprising a plurality of sample image encodings;
determining, based on the visual dictionary, a plurality of first sample indices associated with the plurality of sample image encodings in the first sample feature map;
constructing image encoding corresponding to the plurality of first sample indices in the visual dictionary into a reconstructed feature map; and
decoding, by using the image decoder, the reconstructed image from the reconstructed feature map.

12. The device according to claim 11, wherein determining the plurality of first sample indices comprises:
determining, based on distances between the plurality of sample image encodings in the first sample feature map and respective image encodings in the visual dictionary, the plurality of first sample indices associated with the plurality of sample image encodings from the visual dictionary.

13. The device according to claim 9, wherein the language model is trained by:
extracting a second sample feature map from a second sample image by using a trained image encoder, the second sample feature map comprising a plurality of sample image encodings;
determining, based on the visual dictionary, a plurality of second sample indices corresponding to the plurality of sample image encodings in the second sample feature map;
processing, by using the language model that is being trained, a sample text sequence matching the second sample image to obtain a sample output sequence; and
training the language model based on a predetermined second training objective, the second training objective being configured to reduce or minimize a difference between the plurality of second sample indices and the sample output sequence.

14. The device according to claim 9, wherein constructing the image encodings corresponding to the plurality of indices in the output sequence into the target feature map comprises:
arranging the image encodings corresponding to the plurality of indices in a predetermined order to obtain the target feature map.

15. The device according to claim 9, wherein the image encodings in the visual dictionary have the same dimensionality as a number of channels of the target feature map.

16. The device according to claim 9, wherein the construction of the target feature map and the determination of the target image are performed in response to a detection of an image generation indication.

17. A non-transitory computer-readable storage medium having stored thereon a computer program that, when executed by a processor, implements acts comprising:
processing an input text sequence by using a trained language model to obtain an output sequence output by the language model, the output sequence comprising a plurality of indices in a language dictionary associated with the language model, the language dictionary comprising at least an index set corresponding to text encodings in a natural language and an index set corresponding to image encodings, and the language model being trained on the language dictionary;
constructing image encodings corresponding to the plurality of indices in the output sequence into a target feature map; and
determining, by using a trained image decoder, a target image matching the text sequence from the target feature map, the image decoder being trained on a visual dictionary comprising the index set corresponding to the image encodings.

18. The storage medium according to claim 17, wherein the image decoder is trained by:
processing an input first sample image by using an image encoder and the image decoder that are being trained to obtain a reconstructed image corresponding to the first sample image; and
jointly training the image encoder and the image decoder based on a predetermined first training objective, the first training objective being configured to reduce or minimize a difference between the first sample image and the reconstructed image.

19. The storage medium according to claim 18, wherein processing the first sample image by using the image encoder and the image decoder to obtain the reconstructed image comprises:
extracting a first sample feature map from the first sample image by using the image encoder, the first sample feature map comprising a plurality of sample image encodings;
determining, based on the visual dictionary, a plurality of first sample indices associated with the plurality of sample image encodings in the first sample feature map;
constructing image encoding corresponding to the plurality of first sample indices in the visual dictionary into a reconstructed feature map; and
decoding, by using the image decoder, the reconstructed image from the reconstructed feature map.

20. The storage medium according to claim 19, wherein determining the plurality of first sample indices comprises:
determining, based on distances between the plurality of sample image encodings in the first sample feature map and respective image encodings in the visual dictionary, the plurality of first sample indices associated with the plurality of sample image encodings from the visual dictionary.
